(19) United States
(12) Patent Application Publication
(10) Pub. No.: US 2006/0047963 A1
(43) Pub. Date: Mar. 2, 2006

(54) Method and system for expeditious processing of guaranteed signature documents and the like

(76) Inventors: Julia Brown, Whitby (CA); Eddie Andrukaitis, Richmond (CA); Barry Randall, Ottawa (CA)

Correspondence Address: Stephen B. Salai, Esq.;Harter, Secrest & Emery LLP, 1600 Bausch & Lomb Place, Rochester, NY, 14604-2711, US

(21) Appl. No.: 10/927,752

(22) Filed: Aug. 24, 2004

(51) Int. Cl. H04L 9/00

(52) U.S. Cl. 713/176

(57) ABSTRACT

A method and a system for expeditious processing of guaranteed signature documents. Signers and recipients are enrolled with the guarantee signature company whereby recipients acknowledge the authenticity of the documents signed by the signers. Optionally, a guarantor bond can be provided by the guarantee signature company to the document recipients. Signers must provide the guarantee signature company with personal validation information such as signature samples on hard copy, signature samples on electronic signature capture pad, biometric information such as fingerprint, iris scan, picture and/or video ID and audio ID. The guarantee signature company issues user ID, password and, where applicable, public key infrastructure digital certificate to the signer to forward the signed documents via encryption. The guarantee signature company receives the signed document and transmits it to the recipient, all done in an abridged time frame. The process allows the signers to sign on either hard or soft copy documents. It also accommodates multiple parties signing from different geographical locations.

### FIELD OF THE INVENTION

The present invention relates generally to a system for processing guaranteed signature letters and similar legal documents in a nearly instantaneously expeditious manner in order to reduce time gap between document signature and receipt of the hard/paper copies of the signed documents so as to facilitate implementation of “follow-on” activities which depend on the authenticity and accuracy of the documents being signed by the signer.

### BACKGROUND OF THE INVENTION

In the business areas involving original document signing, such as stockbrokaging, banking, government contracts, securities or real estate transactions, the validity of documents depends on the authenticity of the documents themselves and, where applicable, the signature on these documents. These documents are generally referred to in the relevant industries as “guaranteed signature documents”. As much of the “follow-on” activities, such as shares and securities issuance or release of trust funds from trust accounts, hinge on safe receipt and verification of the authentication of signers on the original hard/paper copies of these documents, the time of receipt of these documents determines the commencement of the “follow-on” activities. Today, transmission of hard/paper copy of original documents are mostly carried out by air and/or land courier, it typically takes 24 hours to complete a continental transmission and, 48 hours or much longer (sometimes up to one week) to complete a transcontinental transmission. This delay in document transmission results in slowing down the commencement of the vital “follow-on” activities, thus creating many undesirable consequences.

The conventional practice requires the signer to attend at a specific place at a specific time to sign the hard copy document. In today's business environment, this is not always possible. For instance, a busy executive may be constantly traveling and therefore impractical for her/him to sign certain hard copy documents at a specific place and time. Under these circumstances, an electronic soft copy signing alternative would be far more desirable, as the signer can access the signing copy through a laptop or personal computer at her/his convenience. However, authenticity and validity of electronic signature remains a concern.

In addition, true identity of the document signers with actual authorities to sign relevant documents are always of concerns. Accordingly, it is desirable to have a neutral third party to act as a guarantor to the signers' signatures whereby the guarantor guarantees the authenticity of the signer and her/his signatures, thus conferring binding authority to the documents signed.

Furthermore, there are many occasions where multiple signers located at different places are required to sign on the same document or different documents with identical contents. Under this multi-party situation, physical signing and transmission of papers quickly add to further delay to the much-needed “follow-on” transactions. Different international time zones simply add to the complication of the multi-party signing logistics.

Heretofore, signature guarantee program such as the one provided by the Uniform Commercial Code of the United States has been adopted and widely used. Under the program, a recognized medallion is issued to a guarantor and the guarantor in turn attest the medallion on the documents that require attestations. The recipients can, under the Uniform Commercial Code, rely on the documents to conduct further transactions. However, this program requires the guarantor to undergo complicated government approval and only very limited entities are qualified to receive the medallion. In addition, this program only works on hard copy original documents and, therefore, creates the same time delay problem discussed above.

Accordingly, it is desirable to have a system which enables: (i) the signer to sign on either hard copy of soft copy documents; (ii) the signer's signature can be verified and validated either physically on hard copy documents, or electronically on soft copy documents; (iii) recipient can receive the signed document without having to second guess the authenticity of these documents and can initiate the “follow-on” transactions with confidence.

By employing such a system, business transactions involving multiple signers can be effectively handled within a much shorter time span notwithstanding the geographical and time zone differences of the individual signers.

### SUMMARY OF THE INVENTION

This invention is designed to overcome the shortcomings of the traditional modes of handing “guaranteed signature document” problems and also provides other ways to process such documents via electronic means.

An object of the present invention is to provide a system whereby both signer and recipient can trust so that when the recipient receives a signed document executed by the signer, she or he can rely on the signature and move to the next steps of the “follow-on” transactions. Accordingly, one aspect of the invention provides a method for expeditious processing of guaranteed signature documents, comprising, under the operation of a user system, the steps of (a) enrolling a document signer and a document recipient with the system; (b) collecting signer's personal validation information by and storing same in the system; (c) issuing public key infrastructure digital certificate and password to the signer and the recipient by the system; (d) the signer signing the guaranteed signature document under witnessing means provided by the system; and (e) receiving the signed document and transmitting the signed document to the recipient by the system.

Another object of the present invention is to provide a system with added security features by having a neutral third party acting as a guarantor in the document signing process. Accordingly, another aspect of the invention provides a method for expeditious processing of guaranteed signature documents, comprising, under the operation of a user system, the steps of (a) enrolling a document signer and a document recipient with the system; (b) collecting signer's personal validation information by and storing same in the system; (c) issuing public key infrastructure digital certificate and password to the signer and the recipient by the system; (d) the signer signing the guaranteed signature document under witnessing means provided by the system; (e) guaranteeing the signed document and issuing a guarantor bond by the system; and (f) receiving the signed document and transmitting the signed document and guarantor bond to the recipient by the system.

According to a further aspect of the present invention, it provides a user system for processing guaranteed signature documents comprising, (a) a guaranteed signature company for administering the operation of signer and recipient enrollment, collecting signer's personal validation information, issuing public key infrastructure digital certificate and password to a signer and a recipient, and receiving the signed document and transmitting the signed document and guarantor bond to the recipient by the system; (b) a database for storage and retrieval of the signer's personal validation information collected by the guaranteed signature company; (c) witnessing means for witnessing the signer's signature; and (d) a document receipt and distribution centre for receiving and distributing either signed or unsigned documents to and from the signer and the recipient.

According to yet another aspect of the present invention, it provides a user system for processing guaranteed signature documents comprising, (a) a guaranteed signature company for administering the operation of signer and recipient enrollment, collecting signer's personal validation information, issuing public key infrastructure digital certificate and password to a signer and a recipient, and receiving the signed document and transmitting the signed document and guarantor bond to the recipient by the system; (b) a database for storage and retrieval of the signer's personal validation information collected by the guaranteed signature company; (c) witnessing means for witnessing the signer's signature; (d) a guarantor for guaranteeing the authenticity of the signer's signature on the documents with issuance of a guarantor bond; and (e) a document receipt and distribution centre for receiving and distributing either signed or unsigned documents to and from the signer and the recipient.

### BRIEF DESCRIPTION OF THE DRAWINGS

FIG. 1 is a block diagram showing the System of the present invention.

FIG. 2 is a block diagram showing the enrollment set up in accordance with the steps of the present invention.

FIG. 3 is a block diagram showing the signing procedures in accordance with the steps of the present invention.

### DETAILED DESCRIPTION OF THE INVENTION

The present inventive system involves the following steps:
Step 1. Signer Enrollment and Recipient Enrollment
Step 2. Personal Validation Information (“PVI”) Collection
Step 3. Public Key Infrastructure (“PKI”) Digital Certificate and Password Issuance
Step 4. Document Signing
Step 5. Document Receipt and Distribution Centre
Step 6. Transmission/Transportation of Signed Document

Each of these steps will be further elaborated with reference to the drawings where appropriate. Since the present invention is adoptable to signing both hard/paper copy and soft/electronic copy documents, both aspects of the inventive features will be discussed.

Step 1. Signer Enrollment And Recipient Enrollment—

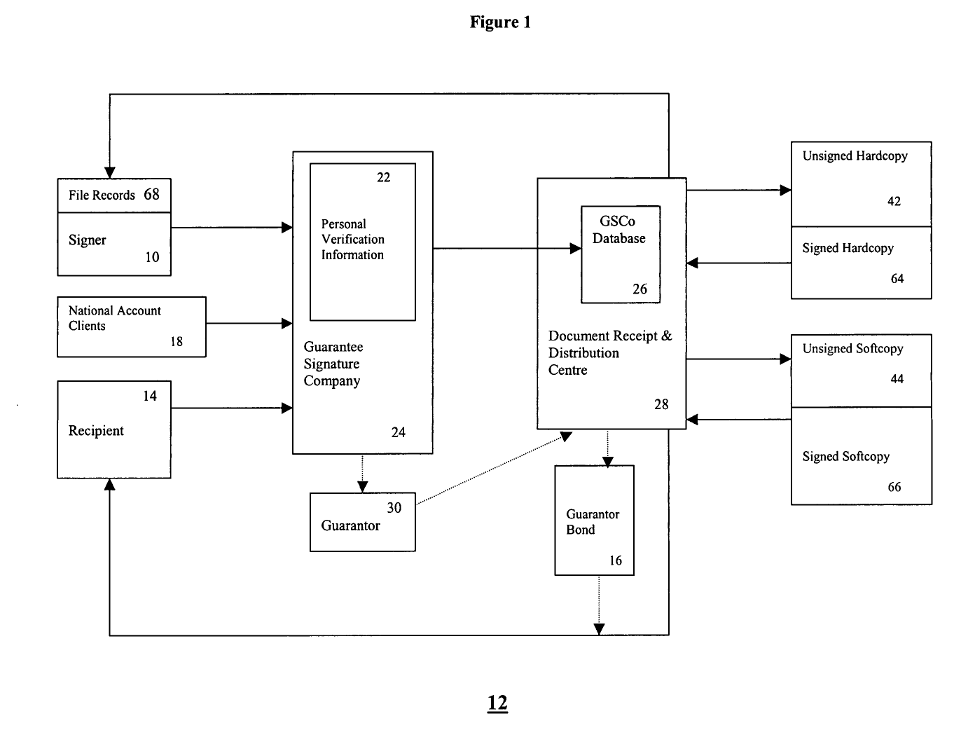

Referring to FIGS. 1 & 2, a Signer 10 enrolls herself/himself with the Guaranteed Signature Document Program (hereinafter the “GSDP” or “the Program”) 12 in person at a client service centre retail outlet managed and administered by the Program Administrator 13 (not shown) of the Guarantee Signature Company (GSCo) 24. By enrolling in GSDP 12, Signer 10 agrees to abide with the procedural requirements of the Program 12.

Likewise, an expectant recipient also enrolls herself/himself with the Program 12 in person at a client service centre retail outlet managed and administered by the Program Administrator 13. By enrolling in GSDP 12, the Recipient 14 accepts the authenticity of the guaranteed signature documents received and honors the procedural requirements of the Program 12.

A Recipient 14 also indicates whether she/he requires an optional Guarantor Bond 16 accompanying the signed hard copy document 64 or soft copy document 66.

Once enrolled, the Signer 10 and Recipient 14 may choose to communicate with the GSDP Program Administrator 13 by either fax, phone, on-line or via any other suitable means.

The Program 12 recognizes the special needs for certain significant and national account clients 18 who are heavy users of GSDP 12. In that case, specialized and dedicated on-line national account terminals 20 are reserved for their quick access. As in the case with individual signers and recipients, initial enrollment and setting up procedures are required with the national account clients 18.

Signer and recipient enrollment can also be effected on-line. For instance, with technologically advanced video and/or audio biometric “readers”, a Signer 10 can submit her/his Personal Validation Information (“PVI”) 22 to the Program Administrator 13 of the GSCo 24 (see below) without having to physically visit a client service centre retail outlet. A Recipient 14 can, likewise, enroll herself/himself electronically. The electronic on-line enrollment is convenient for remote parties and is particularly cost effective if the level of importance of the document to be signed is relatively low.

Once the enrollment step is initiated, Signer 10 and the national account client 18 will be asked to provide her/his PVI 22.

Step 2. Personal Validation Information (“PVI”) Collection

This step allows the GSDP Administrator 13 to collect personal identifying information for reference and validation purposes. Typical PVI 22 will include, but not limited to, some or all of the following: signature samples on hard copy, signature samples on electronic signature capture pad or any other electronic means, biometric information, which may include, but not limited to fingerprint, iris scan, pressure/speed using stylus on electronic pad, picture and/or video ID and audio ID.

The Program Administrator 13 verifies and validates the signer's PVI 22 and, subsequently stores the verified information in a GSDP 12 database located in the Document Receipt and Distribution Centre 28 (see below). In the case of on-line enrollment, PVI 22 can be verified by the Program Administrator 13 by means of advanced technologies which can electronically capture a signer's vital signature statistics, such as signing speed and signing pressure.

Optionally, the GSCo 24 provides and/or acts as Guarantor 30 in the signature validation process. The role of the GSCo Guarantor 30 is to alleviate any doubts in the minds of the Recipient 14 who may be concerned that, despite the best intention of the GSCo 24, the signed documents are either not authenticated or the Signer 10 has no real authority to sign. Thus, the optional GSCo Guarantor 30 provides added values and assurance to all parties involved in the Program 12.

Similar validation information is being collected from representatives of the national account clients 18. Such national account clients are also given the option of using the GSCo Guarantor 30 services to guarantee signatures of their representatives.

Step 3. Public Key Infrastructure (“PKI”) Digital Certificate And Password Issuance

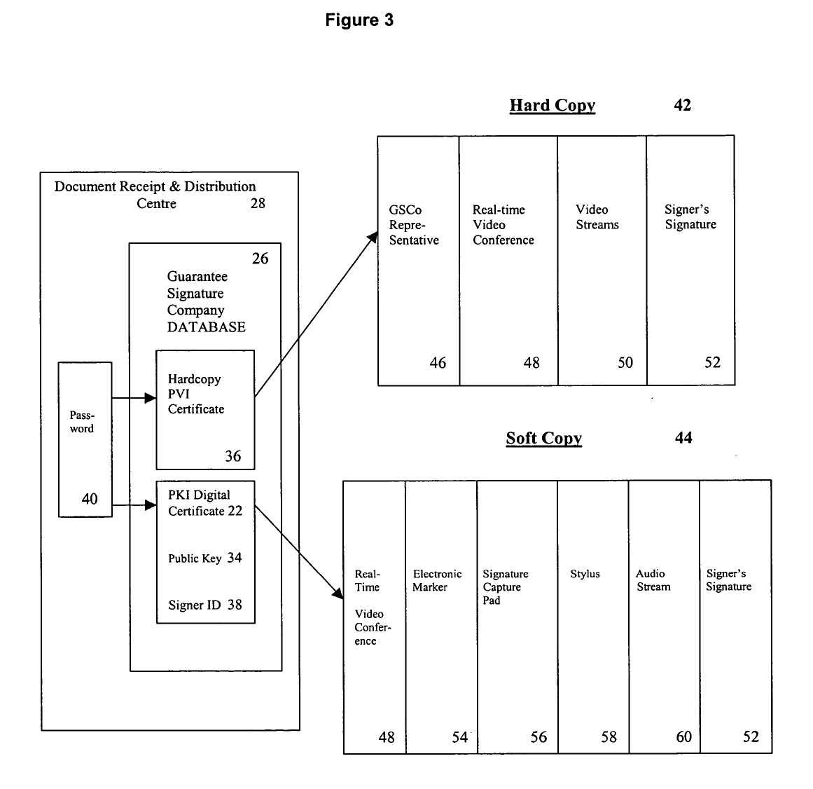

The Program Administrator 13 goes to Document Receipt and Distribution Centre 28 and retrieves the Signer's PVI 22 from GSCo's database 26 and assigns to signer a Public Key Infrastructure (PKI) Digital Certificate 32 and/or a hard copy PVI Certificate 36, plus a Signer ID 38 and Password 40 (see FIG. 3).

The PKI Digital Certificate 32 enables the Signer 10 to stamp his/her electronic signature or marker 54 and forward the signed electronic document using the well established encryption technology. Where the Signer 10 elects to sign documents 66 on hard copies, she will be asked to produce her PVI Certificate 36 by the Program Administrator 13. Signer ID 38 and Password 40 are used to verify Signer's identity.

Step 4. Document Signing

At the document signing stage, the present invention provides for an option for signing on hard copy 42 and an option for signing on soft copy 44.

(A) Hard Copy Signing

Referring to FIG. 3, the Signer 10 (and any other interested parties) attends at a GSDP 12 client service centre and verifies the hard copy document 42 to be signed. The Program Administrator 13 then counter verifies the signer's Signer ID 38 and Password 40 as well as the signer's PVI Certificate 36.

The actual signing is then witnessed by the Program Administrator 13 (and any interested party) by being physically present and/or by watching real time videoconference 48 through video streams 50 taping the Signer 10 signing on the hard copy document 42. Optionally, the video conferencing 50 can be supplemented by audio conferencing 60. This is followed by the Signer 10 herself/himself validating the signing on the intended document 42. Optionally, a representative 60 from the Program 12 (and any other interested party) also validates the signed hard copy document 64. Thereafter, the Program Administrator 13 stamps the signer's PVI Certificate 36 to evidence Signer's signature.

Optionally, where GSCo 24 also acts as the Guarantor 30, the Program Administrator 13 then issues a Guarantor Bond 16 to back the signing authenticity.

(B) Soft Copy Signing

As shown in FIG. 3, if the Signer 10 opts to sign the document online, then the document to be signed is made available by GSCo 24 through Document Receipt and Distribution Centre 28 to the Signer 10 online via one of the well accepted means, such as the Signer 10 goes to the home page of the GSDP 12 and inputting her Signer ID 38 and Password 40 and retrieving the document 44 therefrom. The Signer 10 then verifies the soft copy document 44 to be signed and also retrieves the PKI Digital Certificate 32. Thereafter, the Signer 10 signs soft copy document 44. Since the document 44 is in electronic form, the Signer 10 either signs by using the conventional electronic marker 54 or the Signer 10 can sign by using an enhanced signature capture pad 56 and stylus 58, or by using any other suitable signing means.

The Program 12 requires that the signer's signature 52 to be witnessed. The witnessing can be done by the Program Administrator 13 (and any interested party) by watching real time videoconference 48 through video streams 50 taping the Signer 10 signing on the soft copy document 44. Optionally, the video conferencing 48 can be supplemented by audio streams 60. This is followed by the Signer 10 validating the signing on the intended document 44. Optionally, a representative from the Program 12 (and any other interested party) also validates the signed soft copy document 66.

After signing, the Signer 10 then submits the signed document using her PKI Digital Certificate 32 by encryption. The GSCo 24 verifies the signed document using public key 34 and checks for content hashing to ensure the integrity of the signed document 66. The Program 12 then electronically marks the signed document.

As in the case of hard copy signing, optionally, where GSCo 24 also acts as the Guarantor 30, the Program Administrator 13 then issues a Guarantor Bond 16 to back the signing authenticity.

It should be noted that some of the evidencing tools, such as video and/or audio streams could be used in either hard copy or soft copy signing. In addition, depending on the types and importance of the document to be signed, a recipient may choose the level of security and evidencing requirements suitable to her/his needs. For example, if the document pertains to a financially onerous transaction, the recipient probably wants full security and evidencing steps to be in place when the signer signs the document. On the other hand, if the document to be signed is of low level of importance, then the recipient may just want a video stream witnessing to evident the signing.

Since one of the unique features of the present invention is its ability to accommodate multiple parties from different geographical locations signing either hard copy or soft copy documents, the signing steps described herein allow System 12 to let the multiple signers sign the requisite documents either simultaneously (and parties can view the signing via video streams at the same time) or sequentially (one signs after the other). Alternatively, if the signing parties are conducting businesses in different time zones, then the signing executive can sign at her/his preferred local time using the inventive features of the present System. For example, the signing executives may be located in different countries: one in the United States—Eastern Standard Time (summer daylight saving time); one in United Kingdom—five hours ahead; and one in Japan—13 hours ahead. In this case, using the soft copy signing scheme, Japan may sign first, say at 10:00 am local time and immediately forwards it to the Document Receipt and Distribution Centre 28 (see below) in UK. The UK Centre 28 receives the signed document at about 2:05 pm UK time, then advises the UK executive and forwards the document to the executive at about 2:15 pm who then signs it at 2:30 pm UK time. Thereafter, the document is immediately forwarded electronically to the Centre 28 in New York which then transmits it to the New York executive. The executive in New York receives the document from the Centre 28 at around 9:30 am local time and signs the document and sends it back to the Centre 28 by 9:45 am. Centre 28 then forwards the multi-party signed documents to the intended recipient, say also located in New York. Thus, all subsequent “follow-on” activities to be carried out by the recipient in New York can begin before 10:00 am, local time. In this example, all signing and receiving of the guaranteed signature document are completed within the same date even though it involves signing parties in three continents.

Step 5. Document Receipt And Distribution Centre

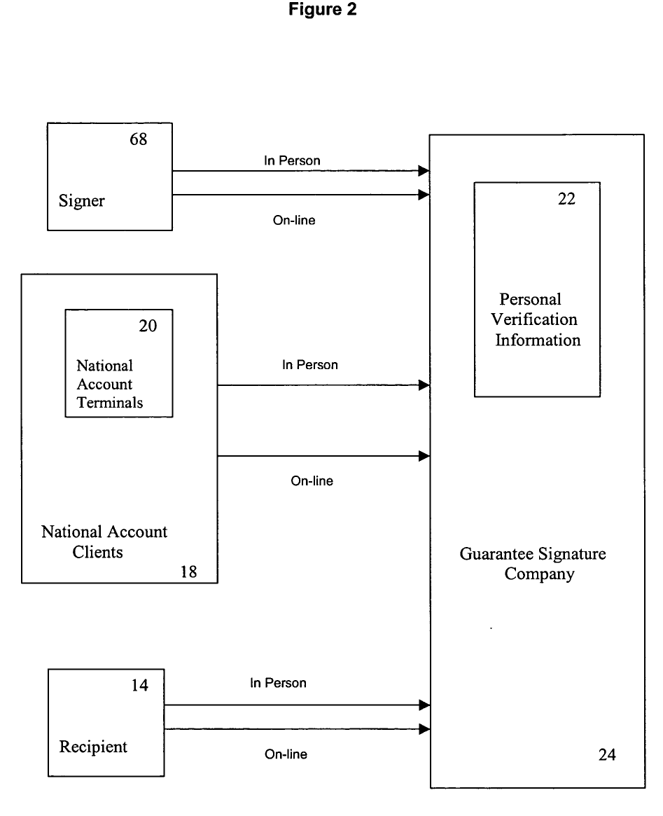

Referring to FIGS. 1, 2 and 3, the Document Receipt and Distribution Centre 28 receives all inputting data from the signer's PVI 22 enrollment steps as well as allows the Program Administrator 13 to retrieve the PVI data 22 when assigning PKI Digital Certificate 32 and/or hard copy PVI certificate 36 to Signer 10. The Centre 28 also collects all signed documents and, where applicable, Guarantor Bonds 16 from the GSCo 24.

The Centre 28 collects all evidentiary proofs and signed documents 64 and/or 66 after stamping or marking by GSCo 24. These includes signed hard copy document 64, with or without Guarantor Bond 16; signed soft copy document 66, with or without Guarantor Bond 16; signer's PVI Certificate 36 stamped by GSCo 24; Signer's PKI Digital Certificate 32 marked by GSCo 24; and video records 50 and/or audio records 60 of signing.

Step 6. Transmission/Transportation of Signed Document

As soon as a hard copy document 64 has been signed, the Centre 28 immediately advises the Recipient 14 before it forwards the signed document 64 together with any Guarantor Bond 16 to Recipient 14 by courier, by scan and e-mail, fax or any other suitable transmission means. The Centre 28 also issues Transmission Proof 62 (not shown) to the recipient for document tracking. Upon receiving the documents, the Recipient 14 acknowledges receipt of signed document. Lastly, the Centre 28 forwards document copy to Signer 10 (and any other interested parties) for file records 68, thus completing the Program 12 process.

In the case of electronic copies, the Centre 28 forwards the signed document to the Recipient 14 by e-mail message and/or other suitable electronic means. The Centre 28 then forwards document copy to Signer 10 (and any other interested parties) for file records 68, thus completing the Program 12 process.

For multiple signers, as discussed in Step 4 earlier, the Centre 28 plays the role of receiving signed documents from the remote signer(s) and either forwards the signed documents to the recipient(s) or to the next remote signer(s). The signer(s) always interfaces with the Centre 28 and its Program Administrator 13 in order to ensure proper handling of the documents.

As can be seen from the foregoing, once the Signer 10 and Recipient 14 have enrolled in the Program 12, the subsequent signing and transmission of the signed document 64 or 66 is highly streamlined and expeditious, both in real time spent in processing the document signing as well as in costs. As soon as the Recipient 14 has received confirmation from the Program Administrator 13 that the documents have been signed, she can immediately commence all necessary “follow-on” transactions without having to wait for the arrival of the hard copy documents.

It is to be understood that the embodiments depicted in the patent specification herein are intended to be merely illustrative and not restrictive in any sense. It is to be further understood that the present invention may be carried out in other specific way than those herein set forth without departing from the spirit and essential characteristics of such invention. The present embodiments are, therefore, to be considered in all respects as illustrative and not restrictive, and all changes coming within the meaning and equivalency range of the appended claims are intended to be embraced therein.

What is claimed is:

1. A method for expeditious processing of guaranteed signature documents, comprising: under the operation of a user system, the steps of
(a) enrolling a document signer and a document recipient with the system;
(b) collecting signer's personal validation information by and storing same in the system;
(c) issuing public key infrastructure digital certificate and password to said signer and said recipient by the system;
(d) the signer signing the guaranteed signature document under witnessing means provided by the system;
(e) receiving the signed document and transmitting the signed document to the recipient by the system.

2. A method for expeditious processing of guaranteed signature documents, comprising:
under the operation of a user system, the steps of
(a) enrolling a document signer and a document recipient with the system;
(b) collecting signer's personal validation information by and storing same in the system;
(c) issuing public key infrastructure digital certificate and password to said signer and said recipient by the system;
(d) the signer signing the guaranteed signature document under witnessing means provided by the system;
(e) guaranteeing the signed document and issuing a guarantor bond by the system;
(f) receiving the signed document and transmitting the signed document and guarantor bond to the recipient by the system.

3. The method of claim 1, wherein said signer's personal validation information includes one or more of the following: signature samples on hard copy, signature samples on electronic signature capture pad or any other electronic means, pressure/speed using stylus on electronic pad, biometric information such as fingerprint, iris scan, picture, video ID and audio ID.

4. The method of claim 1, wherein said signer signing the guaranteed document in Step (d) is either a hard copy guaranteed document or a soft copy guaranteed document.

5. The method of claim 4, wherein the soft copy guaranteed document is distributed to the signer by electronic means and signed by the signer by electronic means.

6. The method of claim 5, wherein the signer signs the electronic document by an electric marker or by providing the signer's signature on a signature capture pad with a stylus.

7. The method of claim 6, wherein the signed document is transmitted to the system by the signer with encryption using the assigned public key infrastructure digital certificate and signer ID and password.

8. The method of claim 1, wherein the user is a national account client with customized dedicated assess to the system.

9. The method of claim 1, wherein the signer and recipient enrollment in Step (a) is effected either in person by said signer and recipient attending a client service center or through on-line means.

10. The method of claim 1, wherein the witnessing means in Step (d) is a person or an video stream or an audio stream capturing the signer's signature.

11. The method of claim 2, wherein said signer's personal validation information includes one or more of the following: signature samples on hard copy, signature samples on electronic signature capture pad or any other electronic means, pressure/speed using stylus on electronic pad, biometric information such as fingerprint, iris scan, picture, video ID and audio ID.

12. The method of claim 2, wherein said signer signing the guaranteed document in Step (d) is either a hard copy guaranteed document or a soft copy guaranteed document.

13. The method of claim 12, wherein the soft copy guaranteed document is distributed to the signer by electronic means and signed by the signer by electronic means.

14. The method of claim 13, wherein the signer signs the electronic document by an electric marker or by providing the signer's signature on a signature capture pad with a stylus.

15. The method of claim 14, wherein the signed document is transmitted to the system by the signer with encryption using the assigned public key infrastructure digital certificate and signer ID and password.

16. The method of claim 2, wherein the user is a national account client with customized dedicated assess to the system.

17. The method of claim 2, wherein the signer and recipient enrollment is effected either in person by said signer and recipient attending a client service center or through on-line means.

18. The method of claim 2, wherein the witnessing means in Step (d) is a person or an video stream or an audio stream capturing the signer's signature.

19. A user system for processing guaranteed signature documents comprising:
(a) a guarantee signature company for administering the operation of signer and recipient enrollment, collecting signer's personal validation information, issuing public key infrastructure digital certificate and password to a signer and a recipient, and receiving the signed document and transmitting the signed document and guarantor bond to the recipient by the system;
(b) a database for storage and retrieval of the signer's personal validation information collected by the guarantee signature company;
(c) witnessing means for witnessing the signer's signature;
(d) a document receipt and distribution centre for receiving and distributing either signed or unsigned documents to and from the signers and the recipient.

20. A user system for processing guaranteed signature documents comprising:
(a) a guarantee signature company for administering the operation of signer and recipient enrollment, collecting signer's personal validation information, issuing public key infrastructure digital certificate and password to a signer and a recipient, and receiving the signed document and transmitting the signed document and guarantor bond to the recipient by the system;
(b) a database for storage and retrieval of the signer's personal validation information collected by the guarantee signature company;
(c) witnessing means for witnessing the signer's signature;
(d) a guarantor for guaranteeing the authenticity of the signer's signature on the documents with issuance of a guarantor bond;
(e) a document receipt and distribution centre for receiving and distributing either signed or unsigned documents to and from the signer and the recipient.

21. The user system of claim 19, wherein the signer's personal validation information includes one or more of the following: signature samples on hard copy, signature samples on electronic signature capture pad or any other electronic means, pressure/speed using stylus on electronic pad, biometric information such as fingerprint, iris scan, picture, video ID and audio ID.

22. The user system of claim 19, wherein said witnessing means is a person or an video stream or an audio stream capturing the signer's signature provided by the guarantee signature company.

23. The user system of claim 20, wherein the signer's personal validation information includes one or more of the following: signature samples on hard copy, signature samples on electronic signature capture pad or any other electronic means, pressure/speed using stylus on electronic pad, biometric information such as fingerprint, iris scan, picture and/or video ID and audio ID.

24. The user system of claim 20, wherein said witnessing means is a person or an video stream or an audio stream capturing the signer's signature provided by the guarantee signature company.
